(19) United States
(12) Patent Application Publication
(10) Pub. No.: US 2016/0102632 A1
(43) Pub. Date: Apr. 14, 2016

(54) HEAT EXCHANGER USING EXHAUST GAS RECIRCULATION GAS

(71) Applicant: Hyundai Motor Company, Seoul (KR)

(72) Inventor: Jung Jae Han, Yongin-si (KR)

(73) Assignee: Hyundai Motor Company, Seoul (KR)

(21) Appl. No.: 14/619,959

(22) Filed: Feb. 11, 2015

(30) Foreign Application Priority Data
Oct. 8, 2014 (KR) 10-2014-0136134

(51) Int. Cl. F02G 5/02

(52) U.S. Cl. CPC F02G 5/02; F02M 25/07

(57) ABSTRACT

A heat exchanger using Exhaust Gas Recirculation (EGR) gas may include a cooling water line including cooling water flowing therein, an EGR line including EGR gas flowing therein and directly exchange heat between the EGR gas and the cooling water in the cooling water line, and an oil line including oil flowing therein and indirectly exchange heat between the oil and the EGR gas through the cooling water while directly exchanging heat between the oil and the cooling water in the cooling water line.

### CROSS REFERENCE TO RELATED APPLICATION

The present application claims priority to Korean Patent Application No. 10-2014-0136134, filed Oct. 8, 2014, the entire contents of which is incorporated herein for all purposes by this reference.

### BACKGROUND OF THE INVENTION

1. Field of the Invention

The present invention relates to an apparatus for heating oil, and more particularly, to a heat exchanger using Exhaust Gas Recirculation (EGR) gas capable of providing robustness against a risk of an engine failure while quickly warming up oil temperature at an early stage of cold start of a vehicle.

2. Description of Related Art

A vehicle includes various kinds of hydraulic mechanisms which are operated by an oil pressure like an automatic transmission. Generally, a mechanical oil pump directly connected to a crank shaft of an engine supplies the oil pressure to the hydraulic mechanisms to smooth an operation of parts of various driving systems.

However, under a cold condition at an early stage of the starting of the vehicle, fuel efficiency is reduced as compared with the condition that the engine is sufficiently warmed-up. For this reason, a friction of the engine is large due to high viscosity of oil in the state in which oil temperature is low at the time of the cold, and a temperature of a wall surface of a cylinder is low and thus a heat loss to the wall surface is large and combustion stability is reduced.

Therefore, to improve the fuel efficiency of the vehicle and durability of the engine, there is a need to quickly increase a temperature of an engine to a normal temperature at an early stage of the starting of the vehicle.

Meanwhile, FIG. 1 schematically illustrates a configuration of an EGR cooler according to the related art. In this case, cooling water flows in the EGR cooler and EGR gas passes through a channel in which the cooling water flows, such that the temperature of cooling water is increased by exhaust heat of the EGR gas to warm-up the engine.

However, according to the related art, only heat exchange between the EGR gas and the cooling water is made, and as a result, since the oil temperature is increased while the warm-up of the engine is performed by the heated-up cooling water, a heat-up time of the oil temperature may be relatively long.

However, to solve the above problem, the EGR gas may be directly exchanged with oil. In this case, however, when cracks or leak occurs at an interface surface between the EGR gas and the oil, the engine failure may occur while oil burning, and the like occurs due to high-temperature EGR gas heat.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a heat exchanger using EGR gas capable of providing robustness against a risk of an engine failure while quickly warming up oil temperature at an early stage of cold start of a vehicle.

According to various aspects of the present invention, a heat exchanger apparatus using Exhaust Gas Recirculation (EGR) gas, may include a cooling water line into which a cooling water flows, an EGR line into which EGR gas flows, wherein the EGR line directly exchanges heat between the EGR gas and the cooling water in the cooling water line, and an oil line into which oil flows, wherein the oil line indirectly exchanges heat between the oil and the EGR gas through the cooling water while directly exchanging heat between the oil and the cooling water in the cooling water line.

The EGR line is configured to pass through the cooling water line, and the oil line encloses the cooling water line.

The cooling water in the cooling water line forms an interface between the EGR line and the oil line to indirectly exchange heat between the EGR gas and the oil.

An inside of the oil line is provided with a heat radiating member.

The heat radiating member is mounted between the oil line and the cooling water line.

The heat radiating member is bent in a zigzag shape.

The heat radiating member bent in the zigzag shape forms a triangular cross section.

The heat radiating member may include a through hole formed on at least one lateral surface of the triangular cross section.

The heat radiating member bent in the zigzag shape forms a rectangular cross section.

The heat radiating member may include a through hole formed on the rectangular cross section in a radial direction of the cooling water line.

The heat radiating member is bent in a zigzag shape along a circumferential direction of the oil line.

The heat radiating member may include a through hole.

The EGR line may have a pipe shape and is provided in plural along a length direction of the cooling water line.

The cooling water line may include an inlet and an outlet that are configured to pass through the oil line.

The inlet and the outlet of the cooling water line are positioned with a 90 degree therebetween.

The inlet and the outlet of the cooling water line are positioned with a 180 degree therebetween.

The oil line may include an inlet and an outlet.

The inlet and the outlet of the oil line are positioned with a 90 degree therebetween.

The inlet and the outlet of the oil line are positioned with a 180 degree therebetween.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view schematically illustrating a configuration of an EGR cooler according to the related art.

FIG. 2 is a view schematically illustrating a configuration of an exemplary heat exchanger according to an exemplary embodiment of the present invention.

FIG. 3 is a view for describing a configuration of a heat radiating member according to an exemplary embodiment of the present invention.

FIG. 4 is a view for describing a configuration of a heat radiating member according to an exemplary embodiment of the present invention.

FIG. 5 is a view for describing a type in which in the exemplary heat exchanger according to an exemplary embodiment of the present invention, an outflow and an inflow of EGR gas are made in an opposite direction.

FIG. 6 is a view for describing a type in which in the exemplary heat exchanger according to the exemplary embodiment of the present invention, the outflow and the inflow of EGR gas are made in a same direction.

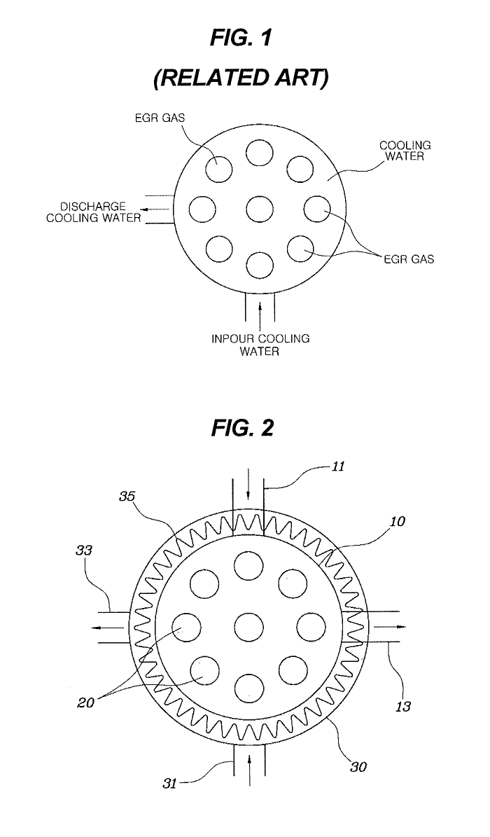

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A heat exchanger using EGR gas according to various embodiments of the present invention is configured to largely include a cooling water line 10, an EGR line 20, and an oil line 30.

Describing in detail various embodiments of the present invention with reference to FIG. 2, first, the cooling water line 10 has cooling water flowing therein and has a tube shape of which the cross section is a spherical shape.

For example, one end of the cooling water line 10 is connected to a cooling water inlet 11 and the other end thereof is connected to a cooling water outlet 13, such that the cooling water flows in the cooling water line 10 through the cooling water inlet 11 and out through the cooling water outlet 13.

Further, the EGR gas flows in the EGR line 20 and is configured to directly exchange heat between the EGR gas and the cooling water in the cooling water line 10.

For example, the EGR line 20 has a shape in which it penetrates through an inside of the cooling water line 10 to directly exchange heat between the EGR gas in the EGR line 20 and the cooling water in the cooling water line 10 with each other.

In this configuration, one end of the EGR line 20 is connected to the EGR inlet 21 and the other end thereof is connected to the EGR outlet 23, such that the EGR line 20 may be provided along a length direction of the cooling water line 10.

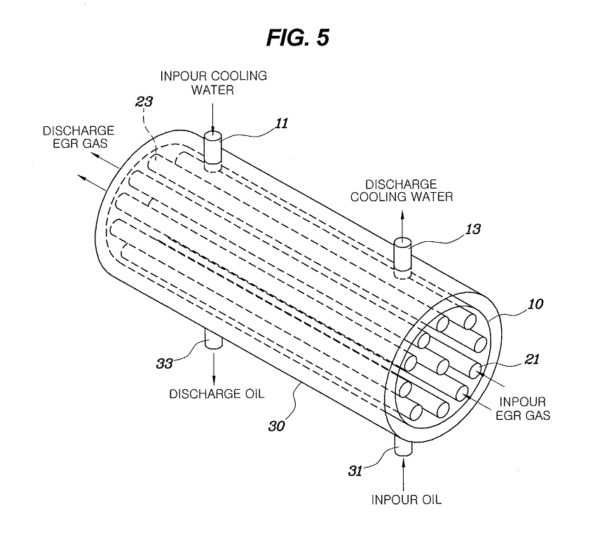

For example, as illustrated in FIG. 5, when the EGR inlet 21 is disposed at one side of the cooling water line 10 and the EGR outlet 23 is disposed at the other side of the cooling water line 10, the EGR gas may flow along the EGR line 20 formed in a straight type.

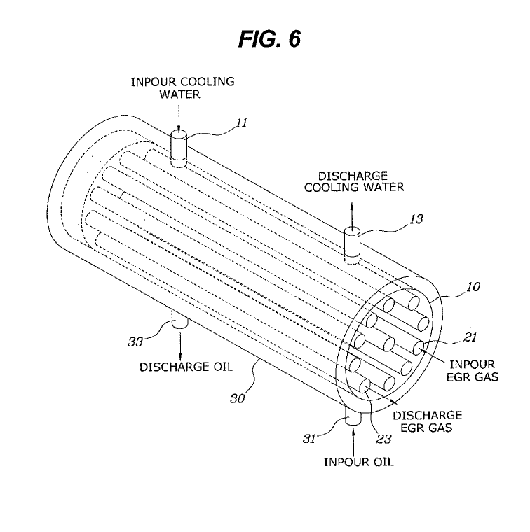

Further, as illustrated in FIG. 6, when the EGR inlet 21 and the EGR outlet 23 are disposed at one side of the cooling water line 10, the EGR gas inpoured through the EGR inlet 21 may be inpoured into a space formed at the other side of the cooling water line 10 and then may be discharged through the EGR line 20 connected to the EGR outlet 23.

Further, the oil line 30 has oil flowing therein and is configured to directly exchange heat between the oil and the cooling water in the cooling water line 10. In this case, the oil is indirectly heat-exchanged with the EGR gas.

For example, one end of the oil line 30 is connected to an oil inlet 31 and the other end thereof is connected to an oil outlet 33, such that the oil flows in the oil line 30 through the oil inlet 31 and out through the oil outlet 33.

Further, the oil line 30 has a shape enclosing an outer surface of the cooling water line 10, such that the oil in the oil line 30 and the cooling water in the cooling water line 10 are directly heat-exchanged with each other.

By the above configuration, the EGR gas is directly heat-exchanged with the cooling water and the cooling water is directly heat-exchanged with the oil to quickly increase the oil temperature at an early stage of the cold start of the vehicle so as to increase the warm-up speed of oil, thereby improving the fuel efficiency and the durability of the engine.

In addition, according to various embodiments of the present invention, the cooling water in the cooling water line 10 may form the interface between the EGR line 20 and the oil line 30 to indirectly exchange heat between the EGR gas and the oil.

That is, the heat exchange between the oil and the EGR gas is not directly performed and the cooling water layer is disposed therebetween, and as a result, the high heat of the EGR gas does not directly affect the oil even though the cracks and leak occur at the interface surface between the EGR line 20 and the cooling water line 10 or the oil line 30 and the cooling water line 10 to prevent the oil burning, and the like from occurring, thereby providing the robustness against the risk of the engine failure.

Meanwhile, an inside of the oil line 30 may be provided a heat radiating member 35 by a welding method, and the like.

That is, the inside of the oil line 30 is provided with the heat radiating member 35 of a material having excellent heat conduction, thereby improving heating performance of the oil and an oil warm-up speed.

For example, the heat radiating member 35 may be bent in a zigzag shape. In particular, according to various embodiments of the present invention, when the oil line 30 has an annular shape which covers an outer peripheral surface of the cooling water line 10, the heat radiating member 35 may be formed in the oil line 30 in a zigzag shape along a circumferential direction.

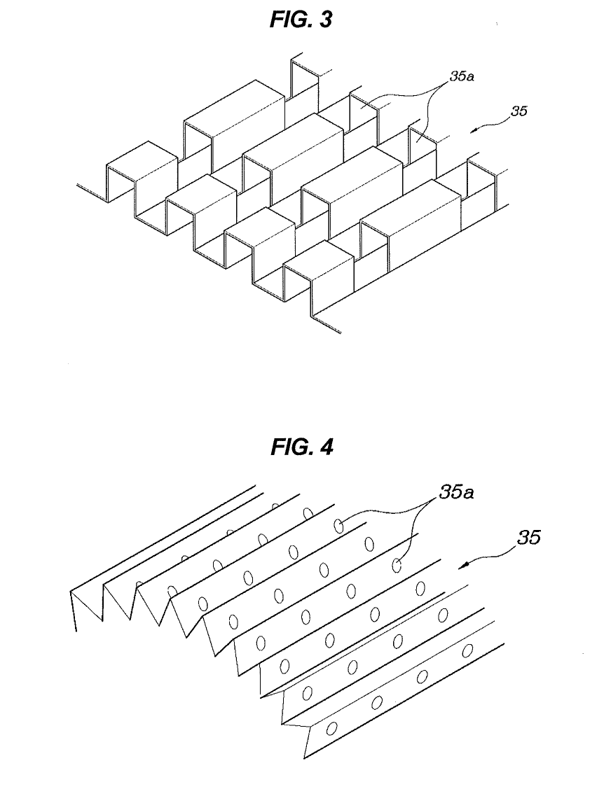

Here, as illustrated in FIG. 3, the zigzag shape may be formed in an offset pin shape or as illustrated in FIG. 4, may be formed in a W pin shape and a middle of the heat radiating member 35 may be provided with a through hole 35a through which the oil may pass.

The through hole 35a may be formed in a radial direction of the cooling water line 10 in an offset pin shape.

The through hole 35a may be formed on at least a lateral side of the W pin shape.

As such, the heat radiating member 35 has a zigzag shape and thus is provided inside the oil line 30 to maximize heat radiating areas, thereby more improving oil heating performance and more improving the oil warm-up speed.

Further, according to various embodiments of the present invention, the EGR line 20 has a pipe shape and thus may be provided in plural along the length direction of the cooling water line 10. That is, several EGR lines 20 are provided inside the cooling water line 10, and thus a cross sectional area of the cooling water line 10 in which the cooling water flows becomes narrow as much as the cross sectional area of the EGR lines 20 to minimize the amount of cooling water flowing along the cooling water line 10, thereby more improving the oil heat radiating performance.

In an exemplary embodiment of the present invention, the inlet 11 and the outlet 13 of the cooling water line 10 are positioned with a 90 degree therebetween. In another exemplary embodiment of the present invention, the inlet 11 and the outlet 13 of the cooling water line 10 are positioned with a 180 degree therebetween.

In an exemplary embodiment of the present invention, the inlet 31 and the outlet 33 of the coil line 30 are positioned with a 90 degree therebetween. In another exemplary embodiment of the present invention, the inlet 31 and the outlet 33 of the coil line 30 are positioned with a 180 degree therebetween.

According to various embodiments of the present invention, the EGR gas is directly heat-exchanged with the cooling water and the cooling water is directly heat-exchanged with the oil to quickly increase the oil temperature at an early stage of the cold start of the vehicle so as to increase the warm-up speed of oil, thereby improving the fuel efficiency and the durability of the engine.

Further, the cooling water layer is disposed between the oil and the EGR gas to prevent the heat exchange from being directly performed, and as a result, the high heat of the EGR gas does not directly affect the oil even though the cracks and leak occur at the interface surface between the respective lines to prevent the oil burning, and the like from occurring, thereby providing the robustness against the risk of the engine failure.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A heat exchanger apparatus using Exhaust Gas Recirculation (EGR) gas, comprising:
a cooling water line into which a cooling water flows;
an EGR line into which EGR gas flows, wherein the EGR line directly exchanges heat between the EGR gas and the cooling water in the cooling water line; and
an oil line into which oil flows, wherein the oil line indirectly exchanges heat between the oil and the EGR gas through the cooling water while directly exchanging heat between the oil and the cooling water in the cooling water line.

2. The heat exchanger apparatus of claim 1,
wherein the EGR line is configured to pass through the cooling water line, and
wherein the oil line encloses the cooling water line.

3. The heat exchanger apparatus of claim 1, wherein the cooling water in the cooling water line forms an interface between the EGR line and the oil line to indirectly exchange heat between the EGR gas and the oil.

4. The heat exchanger apparatus of claim 2, wherein an inside of the oil line is provided with a heat radiating member.

5. The heat exchanger apparatus of claim 4, wherein the heat radiating member is mounted between the oil line and the cooling water line.

6. The heat exchanger apparatus of claim 4, wherein the heat radiating member is bent in a zigzag shape.

7. The heat exchanger apparatus of claim 6, wherein the heat radiating member bent in the zigzag shape forms a triangular cross section.

8. The heat exchanger apparatus of claim 7, wherein the heat radiating member includes a through hole formed on at least one lateral surface of the triangular cross section.

9. The heat exchanger apparatus of claim 6, wherein the heat radiating member bent in the zigzag shape forms a rectangular cross section.

10. The heat exchanger apparatus of claim 9, wherein the heat radiating member includes a through hole formed on the rectangular cross section in a radial direction of the cooling water line.

11. The heat exchanger apparatus of claim 4, wherein the heat radiating member is bent in a zigzag shape along a circumferential direction of the oil line.

12. The heat exchanger apparatus of claim 4, wherein the heat radiating member includes a through hole.

13. The heat exchanger of apparatus claim 2, wherein the EGR line has a pipe shape and is provided in plural along a length direction of the cooling water line.

14. The heat exchanger of apparatus claim 1, wherein the cooling water line includes an inlet and an outlet that are configured to pass through the oil line.

15. The heat exchanger of apparatus claim 14, wherein the inlet and the outlet of the cooling water line are positioned with a 90 degree therebetween.

16. The heat exchanger of apparatus claim 14, wherein the inlet and the outlet of the cooling water line are positioned with a 180 degree therebetween.

17. The heat exchanger of apparatus claim 1, wherein the oil line includes an inlet and an outlet.

18. The heat exchanger of apparatus claim 17, wherein the inlet and the outlet of the oil line are positioned with a 90 degree therebetween.

19. The heat exchanger of apparatus claim 17, wherein the inlet and the outlet of the oil line are positioned with a 180 degree therebetween.
